(19) United States
(12) Patent Application Publication
(10) Pub. No.: US 2003/0191624 A1
(43) Pub. Date: Oct. 9, 2003

(54) Debug function built-in type microcomputer

(75) Inventors: Toshihiko Morigaki, Fujimi-machi (JP); Makoto Kudo, Fujimi-machi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/376,605

(22) Filed: Mar. 3, 2003

(30) Foreign Application Priority Data
Mar. 8, 2002 (JP) 2002-063019

(51) Int. Cl. G06F 9/455; H02H 3/05; G06F 9/44

(52) U.S. Cl. 703/28; 714/30; 714/38; 717/125; 717/135

(57) ABSTRACT

The invention provides a debug function built-in type microcomputer that is capable of creating a readily analyzable debug environment and compressing output information, even when an output signal line having a bit width fewer than a bit width of a command bus is used to trace contents on the command bus. In a debug function built-in type microcomputer, a DBG (debug unit) outputs information to be traced, and status information indicative of contents of the information to be traced from a status generation circuit.

### BACKGROUND OF THE INVENTION

1. Field of Invention

The present invention relates to a debug function built-in type microcomputer, and more particularly to a debug function built-in type microcomputer with an enhanced bus tracing method.

2. Description of Related Art

For purposes of finding errors in a program and supporting correction tasks, a debug function is provided to trace the program, stop the execution of the program when a designated line is reached or an address or data previously set is accessed and notify the same externally, and refer to and change the status of the memory and contents of variables in such an instance.

A related art debug apparatus (debug tool) has the function described above, which is referred to as an in-circuit emulator. A block diagram of a debug system using the in-circuit emulator is indicated in FIG. 8. The debug system in FIG. 8 includes a user target system 50 and a debug tool 55 to debug the same. Further, the user target system 50 includes a microcomputer 51, a memory 52 and an input/output control circuit 53. The debug tool 55 includes a microcomputer to perform debugging 56 and a monitor program memory 57.

In this system, the microcomputer 51 may be removed from the user target system 50 or its operation may be invalidated at the time of debugging, a probe of the debug tool 55 is connected to that section, the microcomputer to perform debugging 56 on the debug tool 55 is operated in place of the microcomputer 51 on the user target system 50, and a monitor program stored in the monitor program memory 57 on the debug tool 55 is executed to control execution of the user program.

Thus, the microcomputer to perform debugging 56 can execute a target program to be debugged that is stored in the memory 52 on the user target system 50, and the microcomputer to perform debugging 56 can output trace information that cannot be obtained from the microcomputer 51 on the user target system 50. Also, in addition to information concerning a processor bus 54, internal information of the microcomputer 51 can also be traced.

However, this method encounters several problems. For example, the entire pins of the microcomputer 51 on the user target system 50 need to be connected to the debug tool 55, and thus the number of signal lines increases and the probing operation becomes expensive, and the probing operation becomes unstable. In particular, this method causes many problems in a microcomputer with a high operation frequency.

FIG. 9 shows a debug system using another related art debug tool.

In this example, a user target system 60 has a microcomputer 61 in which a serial interface 64 required for communication with a debug tool 68, and a sequencer 65 that interprets and executes signals sent from the debug tool 68 are internally built. The sequencer 65 may, according to a signal sent from the debug tool 68, temporarily stop the execution of a user program, make an access to a register 67, and use a bus controller 66 to access a memory 62 and/or an input/output control circuit 63 to thereby control the user program. Since signals from the serial interface 64 cannot be directly connected to a host computer 69 in many cases, the debug tool 68 may convert commands from the host computer 69 to signals that can be understood by the microcomputer 61, and convert signals from the microcomputer 61 to data format that can be understood by the host computer 69.

In this case, since the microcomputer 61 on the user target system 60 has the built-in sequencer 65, and the sequencer 65 makes accesses to the microcomputer 61 or the serial interface 64, its logic circuit to connect to the debug tool 68 becomes complex, and its area on chip becomes large. Furthermore, there is a problem in that, at the time of occurrence of addition of a register, such an occurrence cannot be coped with unless the sequencer 65 is modified.

FIG. 10 is a schematic of a debug system to which the present invention is applied.

The debug system includes a user target system 70, a debug tool 80 and a PC host computer 81. The user target system 70 includes a microcomputer 71, a memory 72 and an input/output control circuit 73. The microcomputer 71 includes a processor core 74 and a debug unit 75. The processor core 74 accesses the memory 72 and/or the input/output control circuit 73 through processor buses 76 and 78 and executes programs. The processor core 74 is connected to the debug unit 75 through an internal debug interface 77 and the internal processor bus 78. The debug unit 75 is connected to the debug tool 80 through an external debug interface 79. The debug unit 75 converts output formats of signals and take output timings between the processor core 74 and the debug tool 80.

The debug system has a normal mode in which a user program is executed, and a debug mode in which a monitor program is executed.

When the processor core generates a debug exception, the debug mode is set. Debug exceptions occur under the following conditions:

Single Step

A debug exception is generated at each execution of each command of the user program.

Command Break

A debug exception is generated immediately before an execution of an address that is set. An address can be set among three locations.

Data Break

When a read/write is executed for an address that is set, a debug exception is generated one or several commands after an execution of the reading/writing. An address can be set only at one location.

Software Break

A debug exception is generated by an execution of a brk command. A saving address at the time of occurrence of a debug exception is an address next to the brk command.

When the debug mode is set, the processor core executes a debug processing routine through the debug unit. By the debug processing routine, the user target program can be stopped at any desired address or executed in single steps. Furthermore, the debug processing routine realizes execution control functions, such as reading and writing in a memory or a register, designation of an end address of the user program, and designation of an execution start address of the user program. Also, when the processor core executes a return command on the debug processing routine to return to the normal mode, the processing returns to the normal mode, jumps over addresses designated by the return command, and restarts executing the user program.

In the meantime, in the normal mode, the debug system executes the user program. In this instance, concurrently, it can selectively trace command information, command address information, data information and data address information.

By employing the system described above, the debug unit 75 having a debug function is included in the microcomputer 71 on the user target system 70. As a result, in realizing the debug function, the number of output signal lines (bit width) that connect the user target system 70 and the debug tool 80 can be reduced. Also, in the normal mode, while the microcomputer 71 is operated on the user target system 70, signals can be traced and a debugging operation can be executed. As a result, responses at a high frequency are possible and accesses to the memory and/or the input/output apparatus can be readily made, such that commands and data during operation can be accurately investigated. Also, the presence of the debug unit 75 is favorable because contents of the memory and the register in the debug tool 80 are not wrongly destroyed by the user program, and contents of the register used by the user are not wrongly destroyed by the debug tool 80.

However, because the internal processing of the CPU of the processor core 74 is entirely executed in 32 bits, reducing the number of output signal lines (bit width) of the external debug interface 79 that connects the user target system 70 and the debug tool 80 causes a problem in that satisfactory real time responses in a bus tracing may become difficult to take place. For example, when the external debug interface 79 has an 8-bit parallel output signal line, it needs a quadruple tracing time or a quadruple transfer speed in tracing contents of a 32-bit width internal bus, which is not practical.

As the internal processing of the CPU is executed in 32 bits, when the processor core 74 shifts to the next operation, the tracing also shifts to the next content, which causes a problem in that the traced result cannot be read. Also, it is difficult to realize a reduction in the number of output signal lines (bit width) in view of their transfer speed. This is contradictory to the demand to reduce the number of output signal lines (bit width) connecting the user target system 70 and the debug tool 80.

Also, when a memory access interrupt occurs by a DMA during memory accesses by the CPU, there is a problem in that the debug tool 80 or the host computer 81 cannot determine which one of the accesses is made by the CPU. Also, the debug tool 80 or the host computer 81 cannot determine whether traced information is a command or data, and no method is available except that such a determination can only be made by the user.

### SUMMARY OF THE INVENTION

As described above, in the related art debug function built-in type microcomputer, when signals are traced while the microcomputer is operated on the user target system, there is a problem in that contents of a 32-bit command bus cannot be completely traced because the number of output signal lines (bit width) that connect the user target system and the debug tool is limited. Also, there is no way, except by the user, to make a determination as to whether traced information is a command or data, and whether it is by the DMA or the CPU.

The present invention addresses or solves the problems described above with a relatively simple method, and provides a debug function built-in type microcomputer that is capable of outputting traced information together with additional information that enables a judgment as to contents of the traced information, creating a debug environment that can be readily analyzed using the additional information, and compressing output information.

To address or achieve the above, the present invention provides a debug function built-in type microcomputer that includes a debug unit having a bus trace function and a bus brake function built in a microcomputer. The debug unit is provided such that, when tracing a bus, the debug unit outputs bus information that is traced and status information indicative of contents of the information that is traced.

As a result, the invention can realize a debug function built-in type microcomputer, which is capable of readily judging contents of bus information by a debug tool using status information, realizing a debug environment that can be readily analyzed, compressing data and address information using the status information, and effectively reading information when an output signal line having a bit width fewer than a bit width of a command bus is used for tracing.

### BRIEF DESCRIPTION OF THE DRAWINGS

FIG. 1 is a schematic that shows a debug system using a debug function built-in type microcomputer in accordance with the present invention;

FIG. 2 is a schematic that shows a related art output method of outputting bus information at the time of tracing;

FIG. 3 is a schematic that shows an output method at the time of compressing positive data in accordance with the present invention;

FIG. 4 is a timing chart representing when positive data is compressed and outputted according to the output method of FIG. 3;

FIG. 5 is a schematic that shows an output method at the time of compressing an address in accordance with the present invention;

FIG. 6 is a timing chart representing when an address is compressed and outputted according to the output method of FIG. 5;

FIG. 7 is a table indicating a status output map according to the present invention;

FIG. 8 is a schematic that shows a related art debug system;

FIG. 9 is a schematic that shows a related art debug system;

FIG. 10 is a schematic of a debug system that uses the present invention.

### DETAILED DESCRIPTION OF PREFERRED EMBODIMENTS

A debug function built-in type microcomputer in accordance with the present invention is described in detail below with reference to the accompanying drawings.

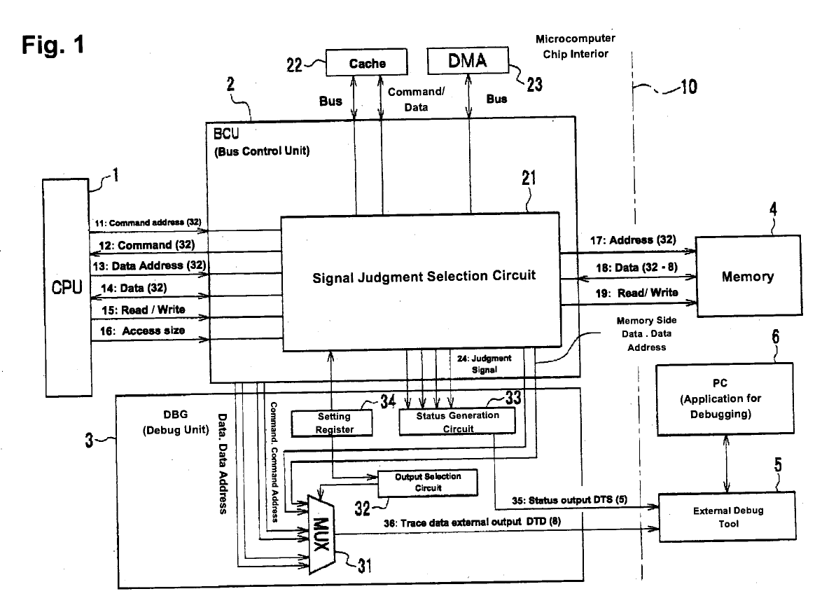

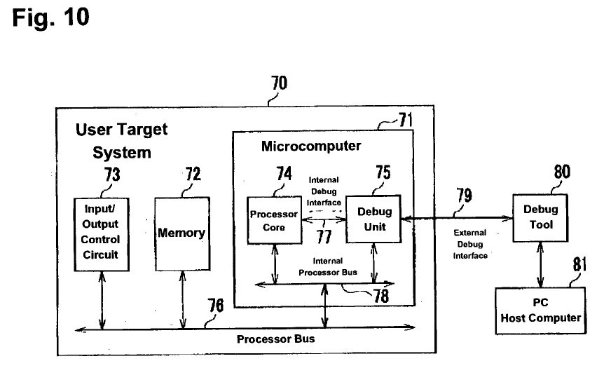

FIG. 1 is a schematic that shows main parts of a debug system using a debug function built-in type microcomputer in accordance with an exemplary embodiment of the present invention. FIG. 1 shows a CPU 1, a BCU (bus control unit) 2, a DBG (debug unit) 3, a memory 4, an external debug tool 5, and a personal computer 6 to perform debugging. Also, FIG. 1 shows a cache memory 22, and a DMA 23. The CPU 1, BCU 2, DBG 3, cache memory 22 and DMA 23 are built in a chip of a microcomputer 10. The microcomputer 10 in FIG. 1 corresponds to the microcomputer 71 in FIG. 10, the CPU 1 and BCU 2 together correspond to the processor core 74 in FIG. 10, the DBG 3 corresponds to the debug unit 75 in FIG. 10, the memory 4 to the memory 72 in FIG. 10, and the external debug tool 5 and the personal computer to perform debugging 6 together correspond to the PC host computer 81. Although the input/output control circuit 73 is not shown in FIG. 10, it is placed in parallel with the memory 4.

The CPU 1 and the BCU 2 are connected through a command address bus 11, a command bus 12, a data address bus 13, a data bus 14, a read/write signal 15 and an access size signal 16. Each of the buses 11-14 has a 32-bit width for transfer. The BCU 2 and the memory 4 are connected through a 32-bit parallel data address bus 17, a data bus 18 and a read/write signal line 19. In FIG. 1, the BCU 2 is connected to a destination that is represented by the memory 4. However, in addition to the memory 4, the data address bus 17 and the data bus 18 may also connect to a peripheral unit and an external memory outside the user target system through an input/output interface not shown in FIG. 1, and send addresses and data to them and receive data from them. Furthermore, the BCU 2 also exchanges data with the cache 22 and the DMA 23. These addresses and data are switched by a signal judgment selection circuit 21 within the BCU 2 and exchanged.

Signals on the command address bus 11, command bus 12, data address bus 13, data bus 14, data address bus 16 and data bus 17 are drawn in the DBG 3 through the signal judgment selection circuit 21 within the BCU 2, selected by a multiplexer 31 within the DBG 3 according to a designation of an output selection circuit 32, and transferred to the external debug tool 5 as an 8-bit width trace data external output (DTD, which corresponds to the external debug interface 79 in FIG. 10) 36. The designation by the output selection circuit 32 is conducted based on information of signals to be traced, which is stored in a setting register 34. The information stored in the setting register 34 is also sent to the signal judgment selection circuit 21 within the BCU 2.

In the meantime, the signal judgment selection circuit 21 within the BCU 2 sends to a status generation circuit 33 within the DBG 3 judgment signals 24 indicative of whether information on a bus is a command or data, whether it is an access by the DMA, what the size of accessed data is, whether it is reading or writing, and the like. The status generation circuit 33 generates statuses of these signals, and outputs the same to the external debug tool 5 as a status output 35 at the same timing as the trace data external output 36 externally outputs bus information.

Since information being transferred on the bus does not contain information that allows it to make a judgment as to whether the information is a command or data, this is judged by the signal judgment selection circuit 21 within the BCU 2. When a memory access occurs at the time of refill/write-back in the cache memory 22, the cache memory 22 also inputs in the signal judgment selection circuit 21 within the BCU 2 a signal indicative of whether it is a command or data to enable the signal judgment selection circuit 21 to make a judgment, and its information is sent to the status generation circuit 33. Also, when a memory access from the DMA 23 occurs, the signal judgment selection circuit 21 sends information thereof to the status generation circuit 33. The status generation circuit 33 sums up these information, and outputs the same as a 5-bit width status output (DST) 35.

By the status output (DST) 35, contents of the bus information of the trace data external output 36 can be readily judged on the side of the debug tool 5 or the personal computer for debugging 6, which provides a debugging environment that can be more readily analyzed, and enhances the debugging efficiency because the user does not need to make a judgment as to contents of the bus information.

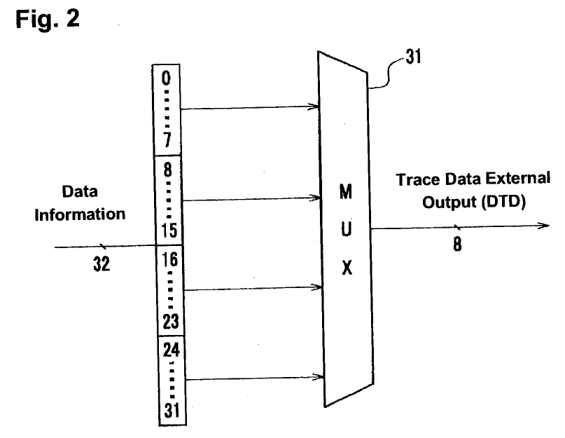

In the related art, when bus information is outputted outside the chip, and its output bit number is fewer than the bit width of a bus, the information on the bus is simply divided into bit sets that can be outputted, and outputted from its lower bits. In other words, when information on a 32-bit bus is outputted in a 8-bit width, lower 8 bits [7:0], the next 8 bits [15:8], the next 8 bits [23:16], and upper 8 bits [31:24] are outputted in this order, as indicated in FIG. 2.

However, in the case of a bus trace, external output of old bus information is terminated at the time when the next information circulates on the bus, and the new bus information is outputted. With respect to data information, if output of the data is terminated when only lower bits thereof are outputted, the data becomes incomprehensible since upper bits thereof cannot be presumed. If the entire data were to be externally outputted, many cycles are required, which is problematic because it may prevent other information from being outputted, or necessary information may be terminated.

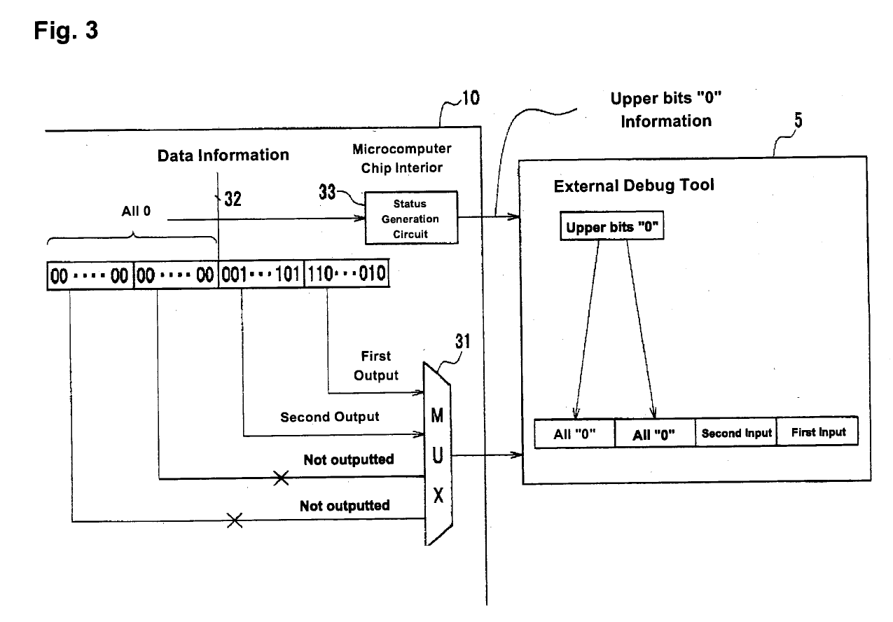

In many occasions, only lower bits of data are normally used in a user program as data values. When data values are positive values, upper bits are filled with “0” in most cases. To make the best use of this characteristic, when upper bits of data are filled with “0”, only lower bits thereof may be externally outputted, and a status output 35 indicates that all the upper bits are filled with “0”, as indicated in FIG. 3. Thus, the upper bits can be filled with “0” to restore the original data on the side of the external debug tool 5 or the personal computer to perform debugging 6.

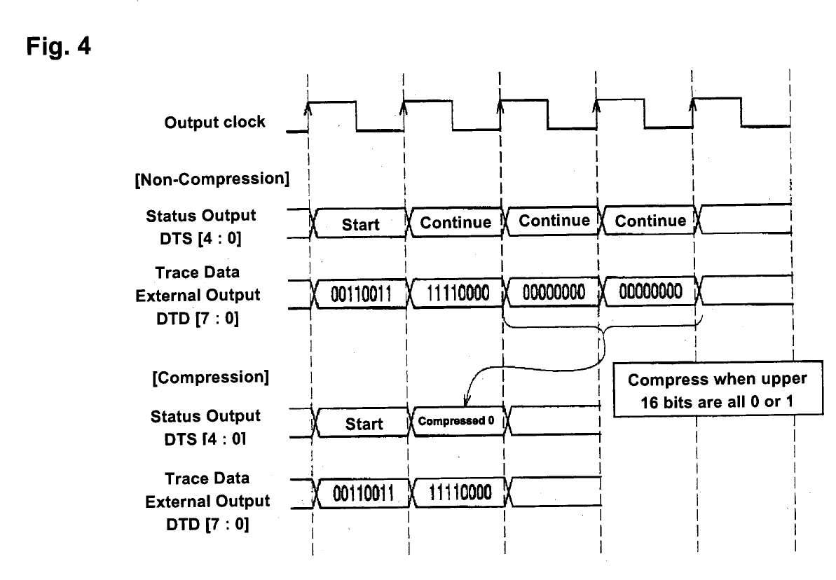

FIG. 4 is a timing chart in the case of “compression” and in the case of “non-compression”. In the case of “non-compression”, an output method indicated in FIG. 2 is used, in which the status output contains outputs for four clocks formed of “Start” and “Continue”. In the case of “compression”, an output method indicated in FIG. 3 is used, in which the status output contains outputs for only two clocks formed of “Start” and then “Compressed 0”.

When values are negative values, they are expressed in complements of 2, and therefore upper bits of data are filled with “1” in most cases. To make the best use of this characteristic, when upper bits of data are filled with “1”, only lower bits thereof are externally outputted, and the status output 35 indicates that the upper bits are filled with “1”. Thus, the upper bits can be filled with “1” to restore the original data on the side of the external debug tool 5 or the personal computer 6 to perform debugging.

When tracing the command bus, the compression of all “0” or all “1” does not operate.

The above describes the case of data values. However, in the case of an address trace, external output of old bus information is similarly terminated at the time when the next information circulates on the bus, and the new bus information is outputted. With respect to addresses, if output of an address is terminated when only its lower address has been outputted, the receiving side may presume that its upper address is equal to a value of an immediately preceding output or may determine that the address be incomprehensible. If the upper address is assumed to be equal to the value of the immediately preceding output, there may be occasions of error judgments. If the entire data were to be externally outputted, many cycles are required, which is problematic because it may prevent other information from being outputted, or necessary information may be terminated.

In this case, the receiving side such as the external debug tool 5 or the personal computer to perform debugging 6 does not presume the upper address. Instead, the DBG 3 side, which outputs the signal, outputs only its lower address, and at the same time the status output 35 indicates that its upper address is equal to that of an immediately preceding output. Thus, on the side of the external debug tool 5 or the personal computer to perform debugging 6, the correct address can be restored, using the upper address of the address received immediately before.

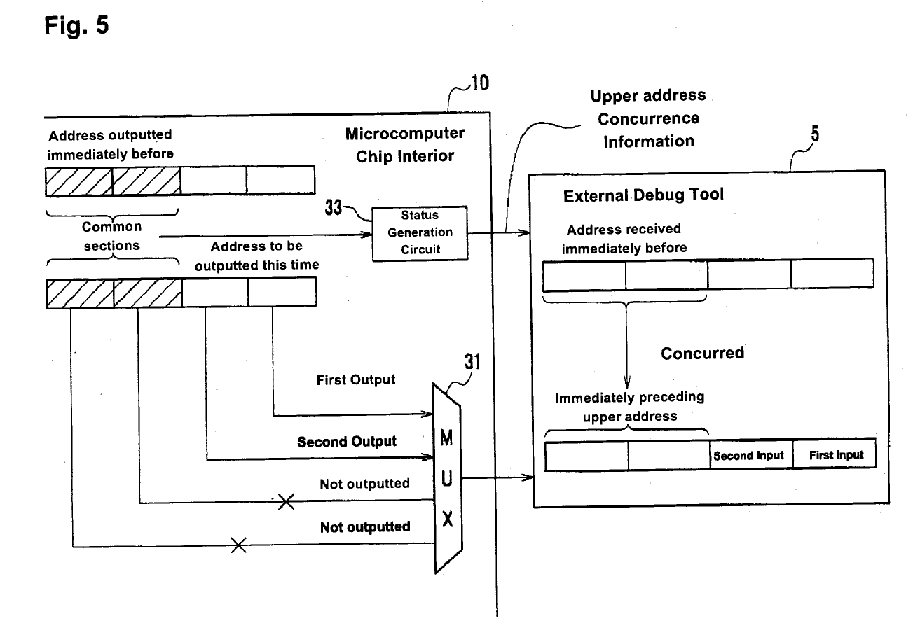

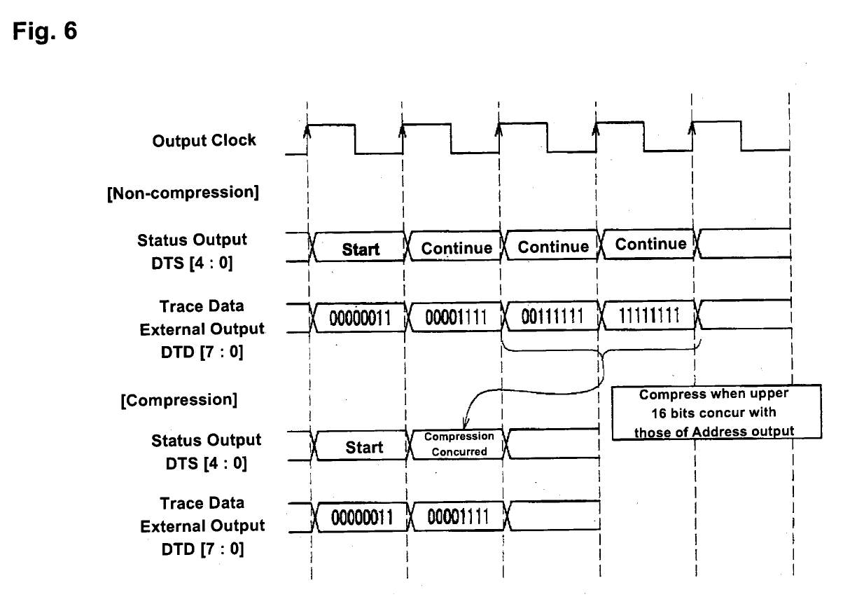

FIG. 6 is a timing chart in the case of “compression” and in the case of “non-compression”. In the case of “non-compression”, the status output contains outputs for four clocks formed of “Start” and “Continue”. In contrast, in the case of “compression”, an output method indicated in FIG. 5 is used, in which the status output contains outputs for only two clocks formed of “Start” and then “Compression Coincided”.

By using each of the methods described above, the amount of information that is to be outputted from the microcomputer 10 to the external debug tool 5 is reduced, and the number of cycles necessary to externally output the entire data information is reduced, such that troubles of terminating outputs halfway are reduced. Also, as a result of the above, other information can be externally outputted in a greater amount, using the same output terminals.

The information contained in the status output (DST) 35 are rearranged and shown below. The status information includes information for classification, output status, size and read/write.

1) Description of Classification

Command

It indicates that address information or data information for a command is outputted.

Data

It indicates that address information or data information for data is outputted.

Read Data

It indicates that data information read out is outputted.

DMA

It indicates that address information and data information for a memory access by DMA are outputted.

2) Description of Output Status

Start

It indicates that output of address information or data information is started.

Continue

It indicates that output of information started with the status of Start is continued.

Compressed 0

It indicates that output of information started with the status of Start is continued, and data of the succeeding 16 bits are all “0”.

Compressed 1

It indicates that output of information started with the status of Start is continued, and data of the succeeding 16 bits are all “1”.

Compression Coincided

It indicates that output of information started with the status of Start is continued, and data of the succeeding 16 bits are equal to upper 16 bits of an address outputted immediately before.

3) Description of Size

B

It indicates a byte access and indicates that data information outputted has a byte size (8 bits).

H

It indicates a half word access and indicates that data information outputted has a half word size (16 bits).

W

It indicates a word access and indicates that data information outputted has a word size (32 bits).

4) Description of Read/Write

rd

It indicates a read access.

wr

It indicates a write access

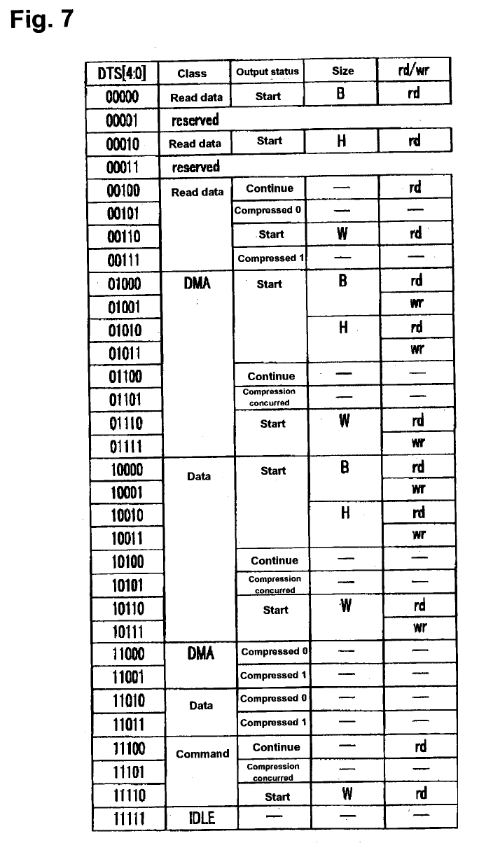

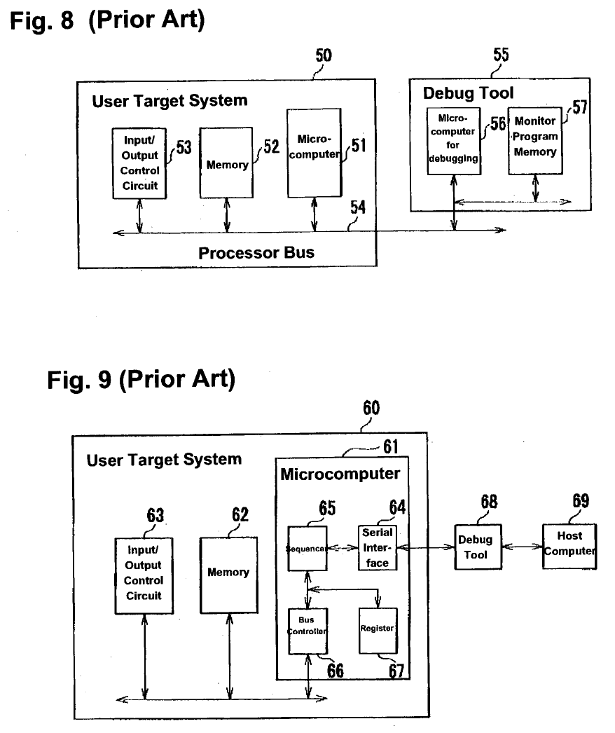

FIG. 7 is a table of a map of the status output (DST) 35 outputted from the status generation circuit 33. It is understood that the details described above are all included in the 32 kinds of outputs of DST [4:0].

As described above, in accordance with the present invention, a debug function built-in type microcomputer is provided such that, when tracing a bus, a debug unit outputs bus information to be traced and status information indicative of contents of information traced.

As a result, the invention can realize a debug function built-in type microcomputer that is capable of readily judging contents of bus information by a debug tool using status information, realizing a debug environment that can be readily analyzed, compressing data and address information using the status information, and effectively reading out information.

The debug unit in accordance with the present invention traces a bus with an output bit width fewer than a bit width of the bus.

As a result, a debug function built-in type microcomputer is provided that is capable of effectively reading out information, even when an output signal line having a bit width fewer than a bit width of a bus is used to provide tracing.

The present invention is provided such that the status information includes information for signal classification, output status, size and read/write.

As a result, the contents of bus information can be correctly transferred by the status information to the debug tool, and a debug function built-in type microcomputer that realizes a readily analyzable debug environment can be obtained.

In accordance with the present invention, when bus information to be traced is positive data and upper bits thereof are all “0”, status information indicating such a status and only lower bits of the data are outputted.

As a result, data information can be compressed using the status information, and information can be effectively read out, even when an output signal line having a bit width fewer than a bit width of a command bus is used to provide tracing.

In accordance with the present invention, when bus information to be traced is negative data and upper bits thereof are all “1”, status information indicating such a status and only lower bits of the data are outputted.

As a result, data information can be compressed using the status information, and information can be effectively read out, even when an output signal line having a bit width fewer than a bit width of a command bus is used to provide tracing.

In accordance with the present invention, when bus information to be traced is an address, and upper bits thereof are all equal to upper bits of an immediately preceding address, status information indicating such a status and only lower bits of the address are outputted.

As a result, address information can be compressed using the status information, and information can be effectively read out, even when an output signal line having a bit width fewer than a bit width of a command bus is used to provide tracing.

What is claimed is:

1. A debug function built-in type microcomputer, comprising:
a debug unit having a bus trace function and a bus brake function built in a microcomputer, the debug unit operating such that, when tracing a bus, the debug unit outputs bus information to be traced and status information indicative of contents of the information traced.

2. The debug function built-in type microcomputer according to claim 1, the debug unit tracing a bus with an output bit width fewer than a bit width of the bus.

3. The debug function built-in type microcomputer according to claim 1, the status information including information for signal classification, output status, size and read/write.

4. The debug function built-in type microcomputer according to claim 1, when the bus information to be traced is positive data and upper bits thereof are all “0”, the status information indicative thereof and only lower bits thereof are outputted.

5. The debug function built-in type microcomputer according to claim 1, when the bus information to be traced is negative data and upper bits thereof are all “1”, the status information indicative thereof and only lower bits thereof are outputted.

6. The debug function built-in type microcomputer according to claim 1, when the bus information to be traced is an address, and upper bits thereof are all equal to upper bits of an immediately preceding address, the status information indicative thereof and only lower bits thereof are outputted.
